(19) United States
(12) Patent Application Publication
(10) Pub. No.: US 2016/0140379 A1
(43) Pub. Date: May 19, 2016

(54) IMPROVEMENTS IN OR RELATING TO USER AUTHENTICATION

(71) Applicant: SECURE FINGERPRINTS AS, Asker (NO)

(72) Inventor: Steinar Pedersen, Asker (NO)

(73) Assignee: Secure Fingerprints AS, Asker (NO)

(21) Appl. No.: 14/899,889

(22) PCT Filed: Nov. 19, 2013
(86) PCT No.: PCT/EP2013/074208

§ 371 Date: Dec. 18, 2015

(30) Foreign Application Priority Data
Jun. 26, 2013 (NO) 20130886

(51) Int. Cl. G06K 9/00; G06F 21/31; G06F 21/32

(52) U.S. Cl. CPC G06K 9/00013; G06F 21/32; G06F 21/316; G06K 9/00087

(57) ABSTRACT

A user authentication method and system is disclosed, in which the same sensor surface is used for scanning a fingerprint and for entry of a user-specific code. The user specific-code comprises gestures that are guided by a frame.

### TECHNICAL FIELD

The present disclosure relates to improvements in or relating to user authentication, and in particular to new methods and apparatus for two-factor authentication where a fingerprint and a user-specific code are used to authenticate a user.

### BACKGROUND ART

We see an increased demand for secure identification of individuals, e.g. as part of access control and user authorization. With an anticipated growing use of smart phones for financial transactions and as “electronic wallets”, the need for a reliable method for authorization of users is mandatory. In this context, different biometric principles have been tried out or employed for identification and authentication, for instance fingerprints, hand prints, ear shape, face shape, voice profile, iris characteristics, etc. Recognition of fingerprints is by far the most popular identification method, where various electronic scanning principles (optoelectronic, capacitive and thermal) are now in wide use for obtaining and storing biometric fingerprint information.

Use of fingerprints alone has the inherent weakness that it is possible to prepare replicas of fingerprints or fingers belonging to individuals subject to impersonation, e.g. in connection with fraud. Such replicas may be provided with the same or similar properties as genuine fingerprints or fingers and may thus be used to provide a fingerprint pattern that will be accepted by a sensor system.

With modern smart phones and tablet computers, touch screens are used for entering information and for operating programs and applications. A consequence of using the touch screen as user/program interface is that the screen will contain an abundance of fingerprint residues stemming from legitimate user(s), where “readable” fingerprints may be easily “lifted off” the screen, e.g. after the equipment has been stolen or lost. Fingerprints thus obtained may be used to spoof the system, either by printing a simple picture or by more sophisticated techniques such as using a laser operated 3-D printer to prepare a “skin-like” structure that may be attached to a fingertip.

For this reason, fingerprint registrations alone are often inadequate and will have to be supplemented with input of a user specific code, assuming that this code is secret and only known to authorized users.

Some currently used systems combine a fingerprint with a personal access code, which is entered by means of a numeric or alphanumeric keypad. In some instances it is inconvenient to use a separate keypad for input of a user specific code, both because this requires extra equipment and also because this implies separation of steps involved in the routine for identification and authentication on two different input entities. A separate, often permanently installed keypad may allow application of utilities such as keystroke loggers that permit illegitimate “reading” of the code during input. Many people also find it difficult to memorize a numeric or alphanumeric code, particularly if the user is required to remember a whole series of such codes.

Several disclosures dealing with fingerprint sensors, user specific code patterns and particular requirements associated with certain sensor types are disclosed in the patent literature.

EP 2584485 A1 discloses a touch based system for entering data comprising at least one digit on a sensor surface.

EP 2575084 A1 discloses techniques provided for entering a secret into a security token using an embedded tactile sensing user interface with the purpose of verifying the secret against a stored representation of the same secret. The security token provides on-card matching functionality.

EP 2509019 A1 discloses a method and arrangement for providing access to a device, where the method comprises receiving via a touch surface a graphical code, said code comprising at least two parts where a first part relates to a first physical value on the touch surface and a second part relates to a second physical value on said touch surface, together generating a graphical code based on said first and second physical values where said graphical code has at least one portion deviating from a plane extension of the touch surface.

US 20120042378 A1 discloses a login system for a graphical user interface where a user sets a design and uses that to get access to a resource. The design can include lines and distances of lines, directions and locations. The design can require a user to select a color and can include colors and amounts by which the different entered parts need to overlap.

WO 2009/008686 discloses a data input device and an input conversion method using the data input device. The data input device includes a detection unit provided in a predetermined input region, the detection unit processing first directional input that generates a first directional input signal through detection of lateral pressing in a predetermined radial direction by a finger placed at a reference location in the input region, second directional input that generates a second directional input signal through detection of vertical pressing in a predetermined direction in a state in which the finger is placed at the reference location, third directional input that generates a third directional input signal through detection of tilt pressing in a state in which the finger is placed at the reference location, and fourth directional input that generates a fourth directional input signal through detection of a tilt input in a state in which the finger is placed at the reference location. A control unit is configured to determine input locations of a lateral pressing direction, vertical pressing direction, tilt pressing direction and tilting direction of the finger and to extract relevant data from memory and input the extracted data.

US 20090313693 A1 discloses a method and system for electronic access security using touches and movements on a touch sensitive surface to determine graphical passcodes that are used in a manner similar to passwords. Graphical passcodes comprise various combinations of swipes, taps or drags on a touchscreen surface as defined by a user. A user's selected graphical passcode is stored in memory for comparison to subsequent entries of graphical passcode in order to authenticate the users.

WO 2009095263 A1 discloses a portable electronic device comprising means for fingerprint user authentication having a fingerprint sensor and means for entering first data, wherein said means for entering first data is coupled to the fingerprint sensor, where said first data are being entered by sensing a presence of an object relative to the fingerprint sensor, where the first data are independent of biometric characteristics of the object.

WO 2003007220 A1 discloses a fingerprint authentication apparatus and method without a keypad, to which a user can input his/her ID number as well as a fingerprint through a fingerprint acquisition window. The fingerprint acquisition window is divided into a plurality of sections and different numerals are being allocated to the different sections. The system comprises a finger position-to-numeral conversion part for locating the position of the finger currently touching the section of the fingerprint acquisition window and for finding a numeral allocated to the corresponding section on which the finger is positioned.

EP 1113405 A2 discloses a fingerprint sensing system usable as a command interface, where a user's fingerprint pattern is recognized and compared to previously stored reference patterns. If the fingerprint pattern matches a previously stored pattern, the user is permitted to enter commands via the same interface system. In the case of an automobile, a user may identify themselves with their fingerprint, and then perform such functions as unlocking the doors, setting the seat to a selected location, or pre-starting the car prior to their entering the automobile.

WO 2002028067 A1 discloses method and system for generating complex text input by sequences of finger touches on a single sign generator in cellular phones that include a display and a sign generator. The sign generator including a finger touch sensitive sensor can be adapted to sense movements in at least one dimension. The system comprises analyzing means and translation means measuring omnidirectional finger movements across the sensor in two dimensions. The analyzing means is used for categorizing omnidirectional finger movements across the sign generator according to predefined sets of finger movement sequences including directional and touch/no-touch finger movement sequences. The translating means including a command table is used for translating the categorized finger movements into signals controlling the display as results of the finger movements on the sensor.

U.S. Pat. No. 8,111,136 B2 discloses a fingerprint scanner including a control module for detecting and controlling the transmission of signals. The fingerprint scanning module is coupled to the control module to detect fingerprints and sense touches, and send fingerprint signals and touch signals to the control module. The fingerprint scanning module includes a touch sensor for sensing different touches that represent different command signals.

U.S. Pat. No. 6,373,967 B2 discloses an entry device that recognizes users' fingerprints which are entered in a sequence, where the fingerprints of different fingers must be entered in the proper sequence in order to be recognized and accepted by the system.

U.S. Pat. No. 6,509,847 B1 discloses a method for inputting an access code via temporal variations in the amount of pressure applied to a touch interface.

CA 2340501 discloses fingerprint or hand palm scanning, where finger- or palm prints are consecutive print images where the subject exerts force, torque and/or rolling over an interval of time.

US 20070122013 A1 discloses a finger sensor that may include a finger sensing integrated circuit (IC) having a finger sensing area, an IC carrier having a cavity receiving the finger sensing IC therein and having at least one beveled upper edge and a frame surrounding at least a portion of an upper perimeter of the IC carrier.

U.S. Pat. No. 8,378,508 B2 discloses a biometric sensor device, such as a fingerprint sensor, comprising a substrate to which is mounted a die on which is formed a sensor array and at least one conductive bezel. The die and the bezel are encased in a unitary encapsulation structure to protect those elements from mechanical, electrical, and environmental damage, yet with a portion of the sensor array and the bezel exposed or at most thinly covered by the encapsulation or other coating material structure.

This inventor has previously disclosed a system for identification and authorization of a person (WO2005043451) that utilizes a fingerprint sensor where the sensor surface is subdivided into sections (physically or virtually) allowing the user to register a user specific code by moving the finger from section to section either horizontally, vertically or diagonally, or to deposit brief taps or exert brief pressure bouts on the sensor surface. The user specific code has the shape of a geometrical pattern, a character sequence or a pressure (dot/dash) sequence.

This system has several drawbacks, of which size requirement is probably the most important. In order to allow the user to draw and/or tap a user pattern with some degree of reliability and reproducibility, the total sensor area should have a size of at least 20×20 mm. This size would allow subdivision of the sensor area into distinct sections, allowing the user to position a fingertip with some degree of precision in different sections as part of drawing the user pattern. However, in contrast to this ideal situation, fingerprint sensors used for practical purposes are considerably smaller, typically around 13×13 mm or smaller.

Another important drawback of the system described according to WO2005043451 is that user patterns are drawn with the entire fingertip in contact with the sensor surface, while dots and/or termination signals are entered by pushing the fingertip against the sensor surface. This procedure will unfortunately leave large fingerprint residues belonging to legitimate users on the sensor surface, enabling illegitimate users to “lift off” the fingerprint, to make replicas and thereby enable unauthorized or criminal use of the fingerprint protected device.

### SUMMARY OF THE INVENTION

According to a first aspect of the disclosure there is provided a method of authenticating a user comprising:
receiving, at a sensor surface, a finger of said user
scanning a fingerprint with said sensor;
receiving, at the same sensor surface, a user-specific code;
wherein the entry of a user-specific code comprises the drawing of a user-specific pattern that comprises one or more gestures guided by a frame.

The fingerprint and the user-specific code are compared with stored records to authenticate a user if the inputs match the records for the user.

Optionally, the gestures comprise a line gesture.

Optionally, the line gesture is input by the swiping of a finger along a portion of the sensor surface adjacent to an edge of the frame.

Optionally, the line gesture comprises a swiping motion from one corner of the frame to another.

Optionally, the gestures comprise a dot gesture.

Optionally, the dot gesture comprises a back-and-forth motion having a terminus at a corner of the frame.

Optionally, the user-specific code starts and/or finishes in a corner of the frame.

Optionally, the gestures comprise a swipe gesture that indicates the start and/or the end of the input of a user-specific code.

Optionally, only part of a fingertip is in contact with the sensor surface during the drawing of a user-specific pattern.

According to a second aspect of the disclosure there is provided a user authentication system comprising:
a sensor comprising a surface which is suitable for receiving a finger for fingerprint scanning and for receiving a user-specific code comprising a user-specific pattern; and
a frame for guiding a user's finger placement of their finger during a drawing of the user-specific pattern on the sensor surface.

Optionally, the frame is provided around the perimeter of the sensor surface or a portion thereof.

Optionally, the frame is perceptible by touch.

Optionally, the frame comprises one or more corners.

Optionally, the frame comprises edges which protrude from the sensor surface and/or a surface of a host device.

Optionally, the frame comprises edges which are recessed with respect to the sensor surface and/or a surface of a host device.

Optionally, the frame or a portion thereof is roughened to provide tactile feedback.

Optionally, the frame comprises a border bounding or at least partially bounding the perimeter or a sensor surface which is visually demarcated from a surrounding surface of a host device and the sensor surface.

Optionally, the frame comprises one or more light emitting portions.

Optionally, the frame comprises one or more portions that emit an audible signal when touched.

Optionally, the frame or a portion thereof comprises a conductive element.

Optionally, the sensor is carried on a host device and the frame is carried on a separate body receives the host device, in use.

Optionally, the host device comprises a portable computing device or smart phone and the separate body comprises a holster for receiving the portable computing device or smart phone, in use.

Alternatively, the host device comprises a transaction card and the separate body comprises a slot for receiving the transaction card, in use.

Optionally, the system comprises
memory means storing fingerprint pattern data and user-specific code data associated with at least one user; and
a processor coupled with said sensor for receiving fingerprint pattern data and for receiving user-specific code data; and coupled with said memory means for comparing said received data with said stored data; and returning an authentication result based on said comparison.

The authentication result is used by a host device to permit specific actions or activities in the event of a successful user authentication, or to deny them in the event of an unsuccessful user authentication.

According to a third aspect of the disclosure there is provided a host device comprising a user authentication system comprising:
a sensor comprising a surface which is suitable for receiving a finger for fingerprint scanning and for receiving a user-specific code comprising a user-specific pattern; and
a frame for guiding a user's finger placement of their finger during a drawing of the user-specific pattern on the sensor surface.

The user authentication system may comprise any of the features of the first aspect or as otherwise described herein, and the host device may be used for carrying out the method of the second aspect of as otherwise described herein.

Optionally, the host device is a mobile computing device, a mobile telephone, a financial transaction card, or an identity card.

According to a fourth aspect of the disclosure there is provided a computer program product encoded with instructions that, when run on a computing device enable it to:
receive fingerprint data and user-specific code data comprising gesture data relating to a user-specific pattern;
compare the received data to stored data; and
return an authentication result based on said comparison.

### BRIEF DESCRIPTION OF THE DRAWINGS

The invention will now be described, by way of example only, with reference to the accompanying drawings, in which:

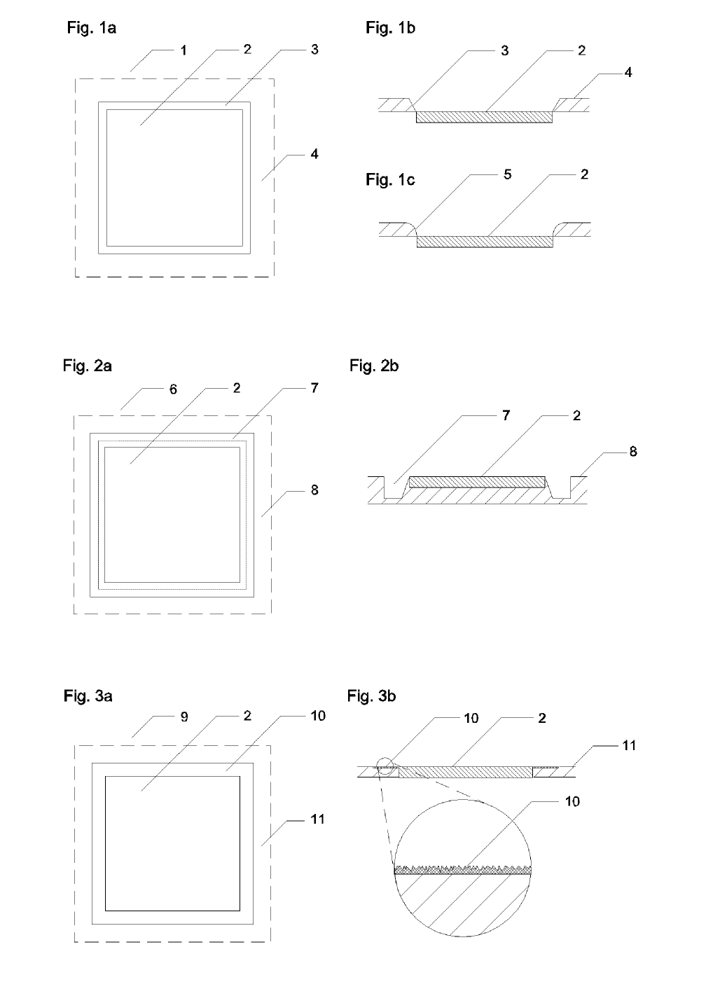

The FIG. 1 series illustrates a fingerprint sensor where the sensor surface is surrounded by an elevated frame.

The FIG. 2 series illustrates a fingerprint sensor where the sensor surface is surrounded by a lowered or sunk frame.

The FIG. 3 series illustrates a fingerprint sensor where the top of the surrounding frame is rough and uneven compared to the sensor surface.

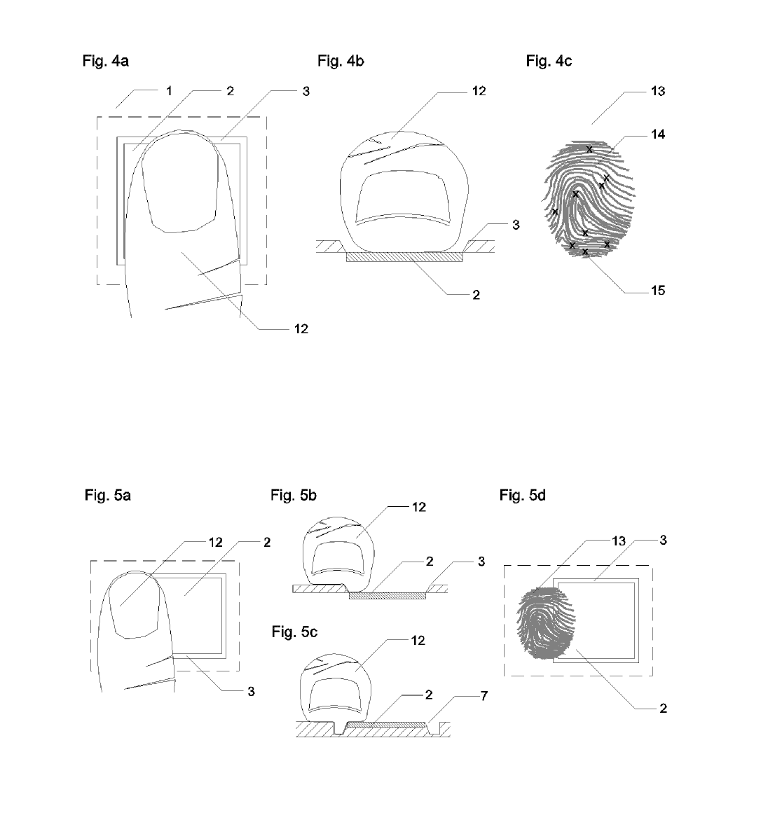

The FIG. 4 series illustrates scanning of a fingerprint at a sensor surface.

The FIG. 5 series illustrates a finger sensing the frame surrounding the sensor surface.

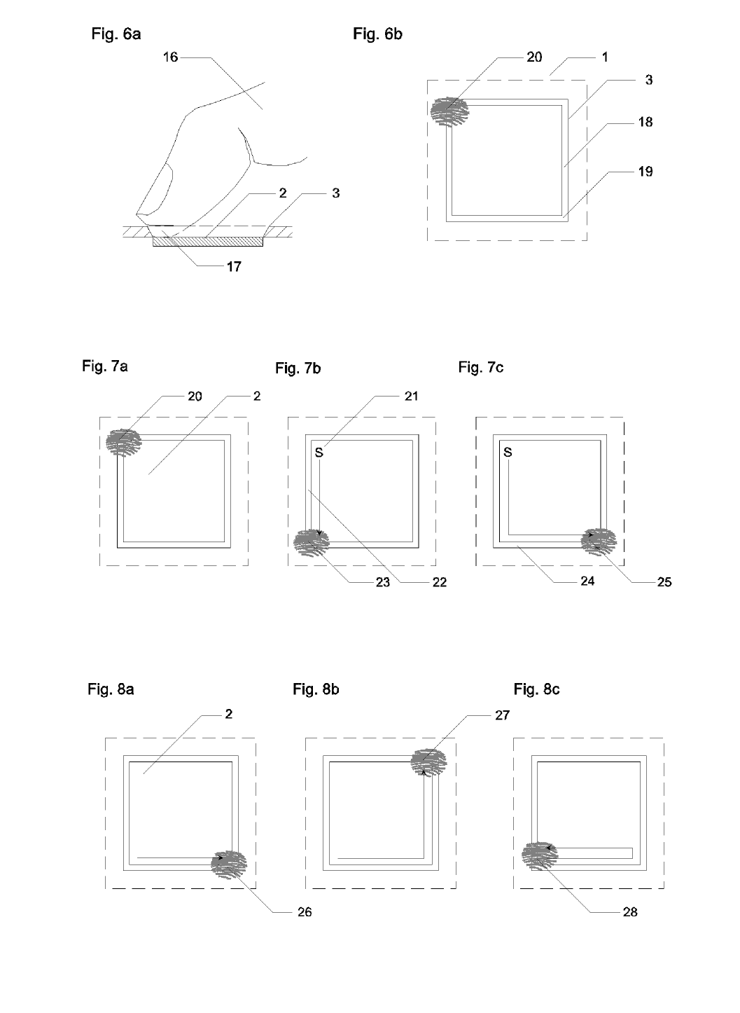

The FIG. 6 series illustrates positioning of a fingertip in one corner of the frame surrounding the sensor surface.

The FIG. 7 series illustrates drawing of a simple line pattern comprising two connected lines, starting in one corner and ending in another corner.

The FIG. 8 series illustrates use of a corner as turning point for the finger while drawing a user pattern.

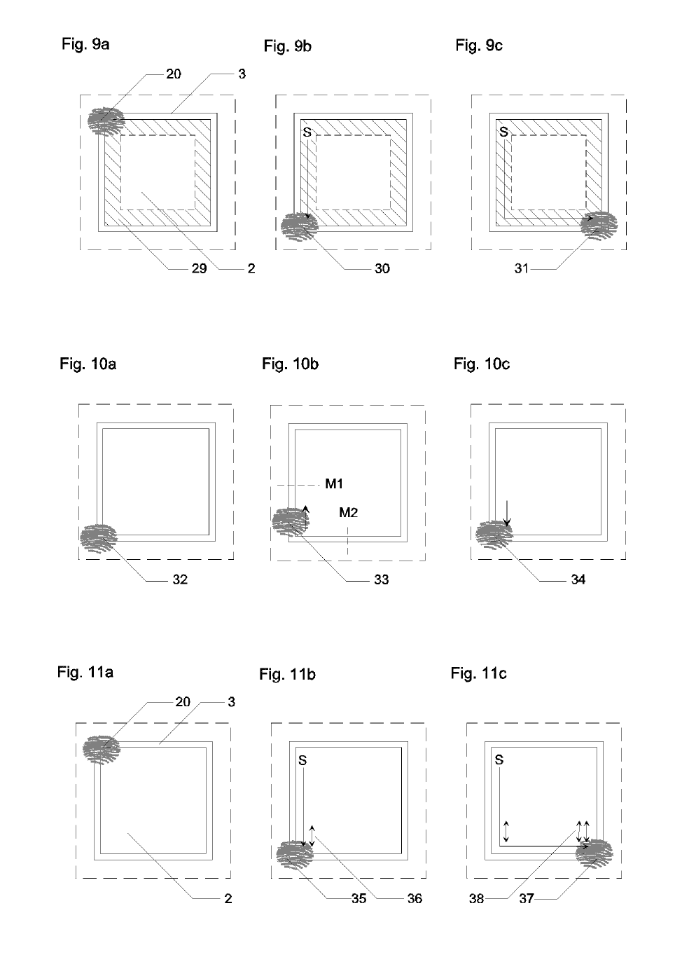

The FIG. 9 series illustrates the location of a fringe region relative to the frame and sensor area and drawing a line pattern within the fringe region.

The FIG. 10 series illustrates an example of entering a single dot in a corner by means of a back-and-forth movement of the fingertip.

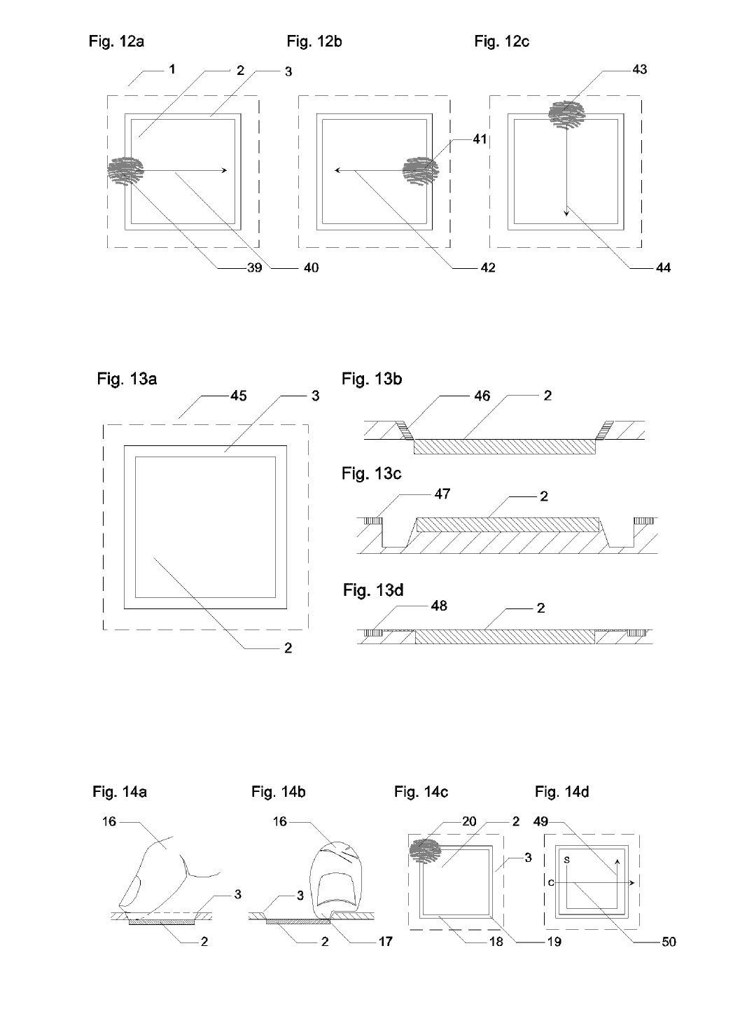

The FIG. 11 series illustrates drawing of a combination pattern comprising lines and dots.

The FIG. 12 series illustrates drawing lines from one edge to the opposite edge of the frame to signify start and/or end of a user pattern.

The FIG. 13 series illustrates a fingerprint sensor where part of the surrounding frame constitutes electrically conducting entities.

The FIG. 14 series summarizes various aspects of a user authentication method.

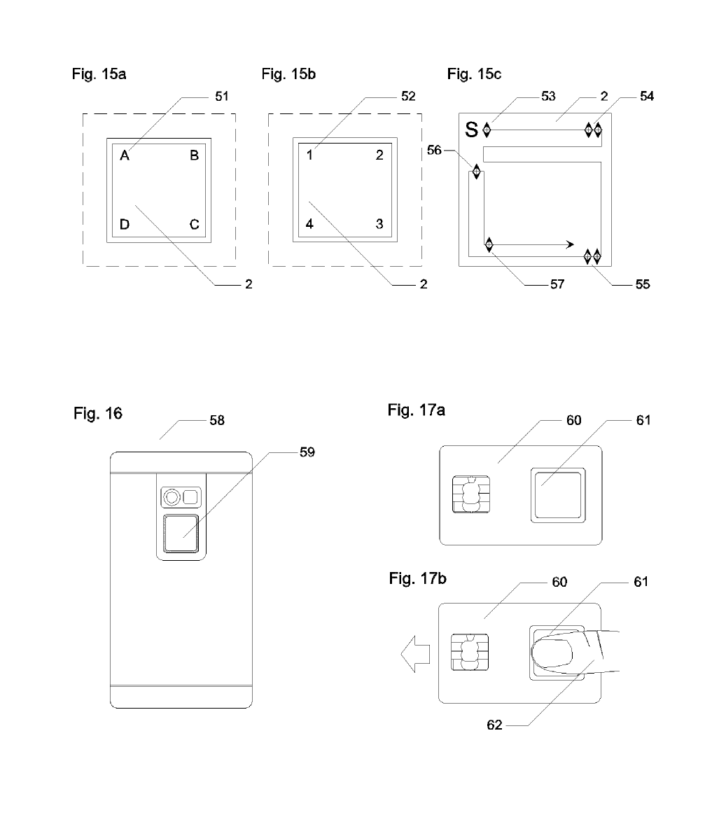

The FIG. 15 series illustrates principles for mapping the corners of the sensor surface and graphic symbolism used for making reference to a user pattern.

The FIG. 16 illustrates a smart phone with a fingerprint sensor on the back.

The FIG. 17 series illustrates a transaction card incorporating a fingerprint sensor and the use of such.

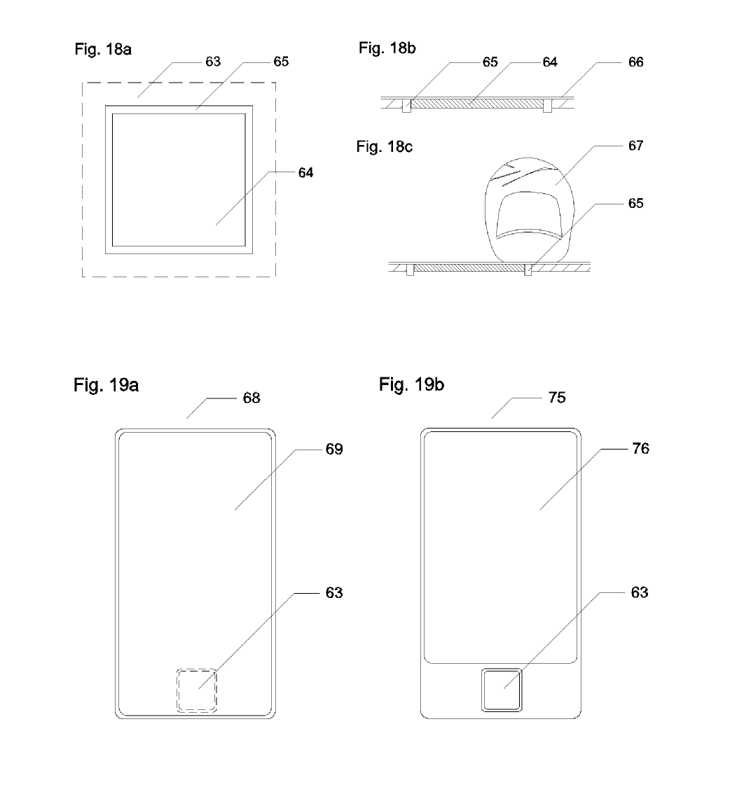

The FIG. 18 series illustrates a sensor system where other means than physical structure is used to locate the sensor frame.

The FIG. 19 series illustrates smart phones where a sensor according to FIG. 18 is incorporated in the display region.

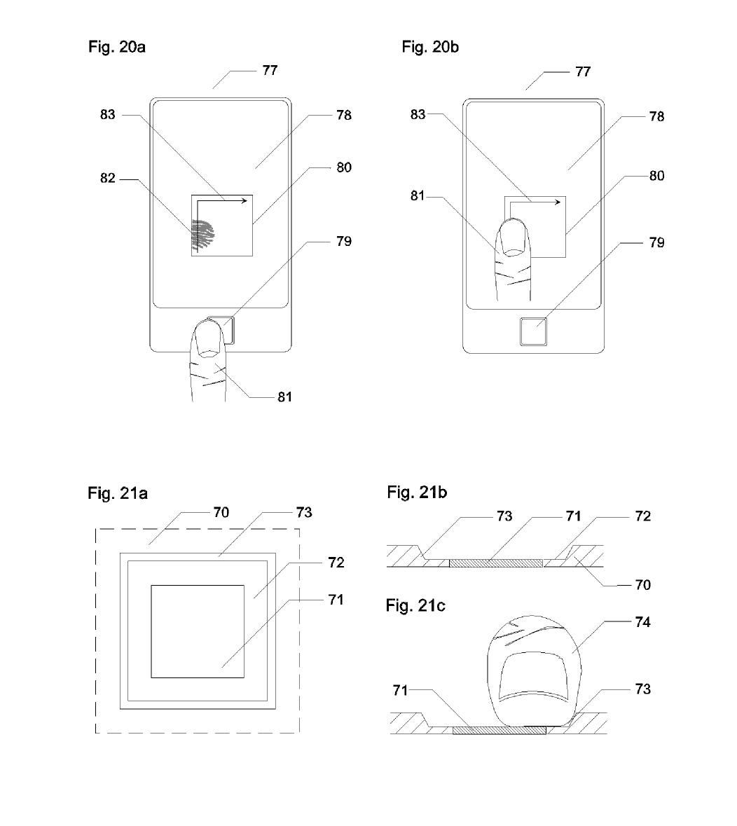

The FIG. 20 series illustrates smart phones where the display provides an image of the sensor frame.

The FIG. 21 series illustrates a frame arrangement useful for small area sensors.

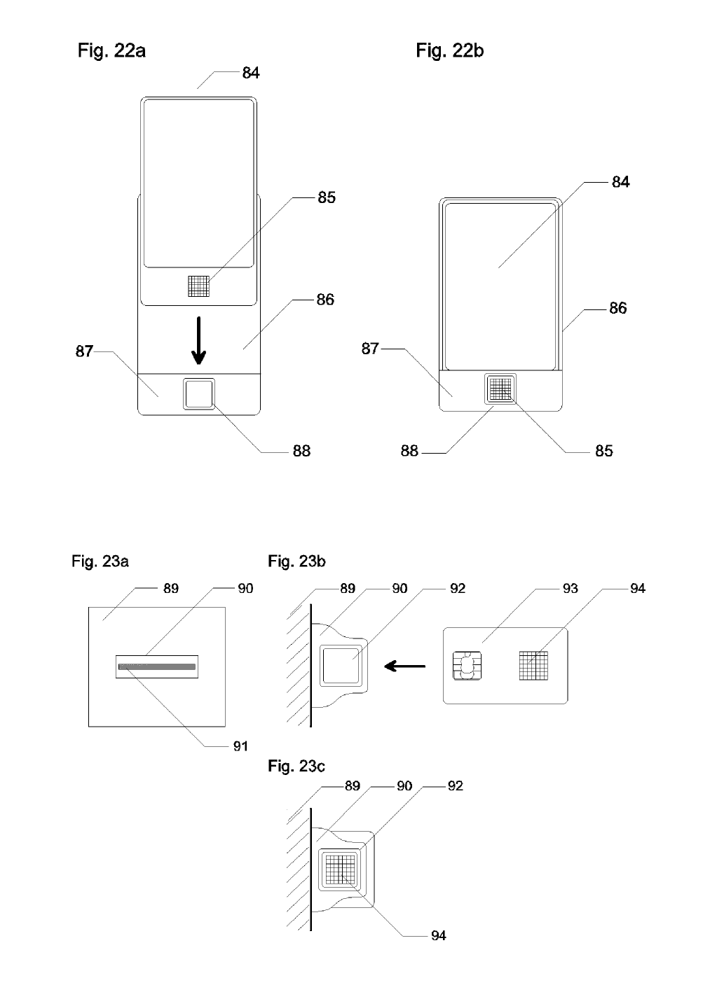

The FIG. 22 series illustrates use of a holster for protecting a smart phone where the holster comprises a square aperture serving as sensor frame.

The FIG. 23 series illustrates use of a transaction card with a fingerprint sensor where the entity receiving the transaction card is equipped with a protruding element comprising a square aperture serving as sensor frame.

### DETAILED DESCRIPTION OF THE INVENTION

The present disclosure provides a method for authentication of users of electronic fingerprint sensors that are based on optical, optoelectronic, ultrasonic, pressure-based, radiofrequency based, thermal, capacitive and other physical principles used for scanning of fingerprints. The method involves input of a fingerprint in combination with a personal, user-defined and user-specific authentication of users by means of one and the same sensor system.

The sensor is used in connection with a system suitable for assessing characteristics of a fingerprint entered in combination with a user pattern by a certain user and for comparing such combination with stored information on fingerprints and user patterns and for using the outcome of this comparison to authenticate (verify) the identity of said user.

The disclosure provides a frame that surrounds the sensor surface or at least part of the sensor surface that can be perceived or sensed by the user during the entry of a user-specific code. The entry of a user-specific code may comprise the drawing of a user-specific pattern, optionally in combination with other elements such as the selective application of pressure by a user's finger. The user-specific code will be discussed in more detail below.

In order to keep full control when drawing a pattern (as part of code entry), the user needs to be constantly aware of their finger's position relative to the sensor surface—for some embodiments even without visual contact with the finger. For this reason, according to preferred modes of operation the user will maintain their fingertip in continuous contact with the frame for entry of the user-specific code. Continuous contact between finger and frame may be maintained both for the entry of a line gesture and a dot gesture as described below.

Furthermore, only part of the fingertip needs to touch the sensor surface in order to be registered during the code entry (drawing) process, and a large part may overlay and even exceed the frame border.

The frame may comprise edges and corners that can be perceived or sensed by the user while entering the user-specific code, and which serve to guide a user's finger while entering the user-specific code or a part thereof. In preferred embodiments, a square or rectangular frame is provided which therefore comprises four edges and four corners.

When guided by the frame, a pattern drawn during the entry of the user-specific code is confined to a fringe region of the sensor surface inside the frame.

The corners of the frame may also play a key role when entering the code. User patterns may be constrained to start and end in corners, and may also provide a reference point for the performance of other gestures such as “dot” gestures as described below.

Although the finger may be put in a random spot on the sensor surface as a preamble to drawing the user pattern, a first move of the fingertip will be towards one of the four corners. This first corner represents the starting point of the user specific pattern.

A corner is the most easily recognizable feature of the sensor arrangement and is therefore ideal as starting point for entry of a user-specific code. A corner may also provide a natural end point for code entry.

Use of a frame also permits incorporation of electrically conducting elements close to the sensor surface, which is advantageous for use with capacitance-based fingerprint sensor systems. For such sensors the frame may form or comprise an electrically conductive element and thus be suited for establishing an electrical potential difference (voltage) between a sensor's capacitor plate array and the finger, which may be used both for fingerprint scanning and also for drawing user patterns when using this kind of fingerprint sensor.

The conducting element may constitute merely part of the frame as long as it is reliably exposed to the finger surface during scanning of the fingerprint and drawing of a user specific pattern.

The conducting element may comprise a suitable bezel, rim or strip made of an electrically conductive material formed on the frame or forming part or all of the frame.

This frame may in some embodiments comprise edges (and therefore corners) that are proud of the sensor surface and/or proud of a surface of a host device at which the fingerprint sensor is provided, forming protrusions that can be sensed by a finger.

Alternatively, the edges (and therefore corners) may be recessed with respect to the sensor surface and/or recessed with respect to a surface of a host device at which the fingerprint sensor is provided, forming recessed channels or depressions which can be sensed by a finger.

The use of protruding or recessed edges serves to guide finger movement during the entry of a user-specific code and so this permits the use of moderate to small area sensors (for example, 13×13 mm or smaller) and enables a high degree of precision and reproducibility during entering of code patterns.

In still further embodiments, the frame may be perceived by the user by other means, including visually (frame imprinted or displayed graphically, emitting light, etc.), audibly (sounding when touched), structurally (corrugated, crenelated or grooved surface) or through tactile means (causing vibrations or stinging sensations when touched). Such effects may be permanent or conditional (e.g. caused by touching the frame or generated as a result of a particular finger position) and may vary in quality and intensity depending on finger position relative to edges and corners of the frame. The terms “touching the frame”, “finger overlaying the frame” and similar expressions used throughout this document may for the latter type of embodiment just signify that the finger is located on top of or close to the virtual representation of the frame.

These “other means” (including visual, audible, structural or tactile means) can also be employed in combination with the protruding or the recessed edges, and/or with each other where possible. For example, a protruding-edged frame could be further enhanced with crenellations, bright coloring and haptic feedback.

As mentioned above, the disclosure involves the entry of a user-specific code. The entry of this code includes the drawing of a user-specific pattern. This is achieved by the user, who in addition to depositing a fingerprint also “draws” a pattern (“user pattern”) using one or more gestures.

These gestures may include different types of gestures, termed herein as a “line gesture” and a “dot gesture”. A line gesture comprises a sweeping motion across the sensor surface, while a dot gesture comprises a brief back-and-forth motion on the sensor surface. Such graphic patterns are easier to memorize than letter- and number codes.

Taps or pressure increases signifying “dots” and “dashes” deposited on the sensor surface may on the face of it represent the easiest way of entering a user specific code by means of a fingerprint sensor. However, this method has several disadvantages. Firstly, tapping a user code on the sensor surface may be audible for people in the close vicinity and may easily be picked up and reproduced by illegitimate users. Secondly, a sequence of dots and dashes provides a limited number of code alternatives unless the code is very extensive and consequently very lengthy (and difficult to remember).

An alternative to tapping dots and dashes is to put the fingertip against the sensor surface and to exert an increased pressure for a brief moment (“pressure bout”), simulating tapped dots and dashes. This exercise puts a certain strain on the finger, however, and it may also be difficult to discriminate between individual dots and dashes deposited this way.

This inventor has discovered that the approach taken for entering user specific line patterns may also have applicability when using dots as part of a user defined pattern. Here again, corners of the frame play a key role. While the fingertip is residing in or upon one of the corners, the user performs a brief movement of the finger along one of the adjoining edges and back into the corner. This brief back-and-forth movement is easy to perform and is easily picked up by the sensor. This dot deposition method is easily integrated with line pattern drawing (moving a finger from corner to corner) and may significantly increase the number of user patterns available within the framework of the method provided by the present disclosure.

Alternatively, despite its disadvantages as outlined above, the dot gesture could be provided by the pushing of a fingertip against the sensor surface.

The user pattern may either comprise a sequence of a defined number of lines (“line pattern”), a sequence of a defined number of dots (“dot pattern”), or a sequence of a defined number of lines and dots in combination (“combination pattern”).

The user pattern may be drawn starting in one of the four corners and also ending in a corner, and the corners may furthermore serve as turning points for the finger while drawing line patterns and combination patterns. The user pattern will preferably comprise at least two connected lines, and may optionally comprise dot patterns entered in corners of the frame. Lines entered on the sensor surface wholly or partially outside the fringe region may represent signals indicating start and/or end of input of a user pattern.

More specifically, when entering line patterns, a method for authentication of users of electronic fingerprint sensors involves the user putting a fingertip in a random spot on the surface and moving it into (or onto) one specific corner of the frame or alternatively positioning the fingertip directly in the corner. The finger is thereafter moved along one of the two adjoining edges to another corner, where the line pattern is either finalized or where the finger is alternatively moved onwards along one of the two adjoining edges into yet another corner or to the previous corner. The line pattern is either finalized in this corner or the general pattern involving moving the finger along edges from corner to corner is repeated a desired number of times until the line pattern is completed. Input of sequences of finalized, continuous line patterns (comprising connected lines) may be performed one or several times in order to obtain the complete user pattern.

Alternatively, when entering combination patterns, a method for authentication of users of electronic fingerprint sensors involves the user putting a fingertip in a random spot on the surface and moving it into (or onto) one specific corner of the frame or alternatively positioning the fingertip directly in the corner. Here, the user either enters a dot pattern comprising one or more dots while the fingertip resides in this corner, or immediately moves the finger further along one of the two adjoining edges to another corner. Here, the user either finalizes the combination pattern, alternatively enters a dot pattern comprising one or more dots while the finger resides in the corner, or moves the finger onwards along one of the two adjoining edges into yet another corner or to the previous corner. Here, the combination pattern is either finalized or the general drawing pattern comprising lines and dots with a finger moving along edges from corner to corner is repeated a desired number of times until the combination pattern is finalized. Input of sequences of finalized combination patterns (comprising connected lines) may be performed one or several times in order to obtain the complete user pattern.

Single dots as part of combination patterns may be entered by the user moving the fingertip rapidly out of a corner and back into the same corner (back-and-forth movement). A “dot” can be recognised as having a back-and-forth movement where one leg of the movement is below a certain threshold. An example of a suitable threshold may be a distance that is less than 50% of the length of the shortest of the adjoining edges. The movement is preferably carried out along the edge pointing in the same direction as the finger while drawing the pattern. Multiple dots may be entered by repeating the above back-and-forth movement.

Single dots as part of combination patterns may alternatively be entered by the user increasing the pressure one or more times while the fingertip resides in a corner.

The method may also include a process whereby the user draws one or more lines across the sensor surface from one edge to the opposite edge to indicate start and/or completion of a user pattern. This motion may also serve to wipe clean any fingerprint patterns that have been deposited on the sensor surface.

An important prerequisite for carrying out the method according to this invention is the requirement of using a fingerprint sensor (1; FIG. 1a) where the sensor surface (2) is surrounded by a perceptible frame (3). The frame itself may in some embodiments constitute part of the device body (4) or otherwise be constructed so that the user will sense the outer border of the sensor surface when moving a finger across the edges of the frame. FIG. 1b illustrates an embodiment where the frame (3) is elevated relative to the sensor surface (2) and may constitute a square or rectangular aperture in the casing (4) enclosing the device. The frame may comprise straight edges (3) as indicated in FIG. 1b, or the edges (5) may be slightly rounded as shown in FIG. 1c. Instead of using frames with completely square corners (as used herein to simplify drawings), the corners may also be slightly rounded or “cut off” in order to improve ergonomics and looks without departing from the basic principles of the invention. The fingerprint sensor itself (1) is illustrated in this document for simplicity in the shape of a square plate. However it is to be recognized that modern sensors are ultrathin and comprise a complicated internal structure and an external rim of contact points that have not been illustrated, as the sensor's form and structure have no bearing on the execution of methods according to the invention.

An alternative frame construction also meeting the requirement of using a perceptible frame for executing the method is illustrated in FIG. 2. Here, the frame (7) is sunk compared to the sensor surface (2) and has the shape of a groove, allowing the sensor surface (2) to be aligned with the level of the device casing (8).

When employing the method with transaction cards, access cards, etc., use of a bulky sensor/frame construction is not permitted. For such applications, the surface of the frame or a portion thereof may be made perceptible by being roughened, by altering the structure or texture of the frame as compared to the rest of the card face, which will usually be smooth or polished. This principle is illustrated in FIG. 3, where the sensor surface (2) is surrounded by a frame (10) having a corrugated, ridged, grooved or knurled structure in contrast to the plain outer surface of the card body (11).

Even though it makes sense to use a square or rectangular frame for bordering a square or rectangular sensor surface, it is also possible to use a triangular or polygonal (>4 sides) frame if that may be needed for certain purposes.

The FIG. 4 series illustrates the scanning of a fingerprint at a sensor surface (2). Use of a frame (3) with elevated edges facilitates positioning of the finger (12), securing a rapid and reproducible fingerprint scanning. A fingerprint (13) including ridges (14) and minutiae (15) is shown in FIG. 4c.

The FIG. 5 series indicates how pronounced edges of a frame according to two different construction principles serve to make the user feel the outline of the sensor surface (3), first showing the fingertip (12) bridging the inside and outside of an elevated frame (3) according to FIG. 5b and also how the lowered or sunk frame (7) is sensed by the finger according to FIG. 5c. A conceptual fingertip imprint (13) relative to the sensor surface (2) and frame (3) is shown in FIG. 5d to indicate that the largest part of the fingertip surface may be located outside the sensor area during drawing of user patterns.

When drawing user patterns, the fingertip is more elevated than when depositing a fingerprint, as illustrated in FIG. 6a. Here, when drawing a pattern, the fingertip (16) is oriented at an angle of approximately 60° relative to the sensor surface (2). A typical angle of elevation will be 50-70°. The finger is resting in or upon one of the four corners of the frame (3), as indicated by the oval contact surface (20) in FIG. 6b. (For simplicity, the terms “in a corner” or “in the corner” are generally used throughout this document, although the fingertip may actually rest at or upon the corner). Only part of the fingertip (17) will actually touch the sensor surface. According to terminology used herein, a four-sided, square or rectangular frame will comprise four edges (18) and four corners (19). While drawing user patterns, the fingertip will be moved along edges (18) and into (or onto) corners (19) with the contact surface (20) overlaying and to a large extent moving outside the outline of the frame (3).

The FIG. 7 series illustrates the drawing of a simple, two-legged user pattern (line pattern). The drawing starts with the user putting a fingertip in the upper left corner (20; FIG. 7a), which represents the starting point of the user pattern. The user may alternatively start the drawing process by positioning the finger elsewhere on the sensor surface (2) and subsequently move the fingertip into said corner (20). The starting point of the pattern is signified by the symbol “S” (21; FIG. 7b). The fingertip is thereafter moved along the left-hand edge (22) to the lower left corner (23) and further along the adjoining lower edge (24; FIG. 7c) to the lower right corner (25) whereupon the L-shaped user pattern is completed.

The corners of the frame represent key locations indispensable for executing the method according to the invention. They represent start and end points for drawing user patterns, and furthermore represent turning points for the fingertip while moving within patterns. This is indicated in the FIG. 8 series, where the fingertip at one point is located in the lower right corner (26; FIG. 8a). In accordance with one basic principle of the method (continually touching the edges of the frame during pattern input), the user has two options (except for ending the pattern in this corner), either to move the fingertip to the upper right corner (27; FIG. 8b) or to return the fingertip to the lower left corner (28; FIG. 8c). In either case, the corner serves as a turning point for the fingertip, easily recognizable even without visual contact when a physically distinct frame is used. This in contrast to earlier described methods (including principles disclosed in WO2005043451) where patterns are drawn or tapped on the sensor with reference to specified surface segments or designated/numbered areas, basically independent of the sensor's corners.

The FIG. 9 series illustrates that as a consequence of the fingertip following the sensor frame (3) during pattern drawing, the part of the contact area (20) actually touching the sensor surface (2) during the drawing process is quite small. The contact between finger and sensor is actually confined to a fringe region (29) shaded as the outer part of the surface range (2). The dimensions of this fringe region (29) are not absolute and will depend on the drawing practice of different users. However, as different users may require different fringe region dimensions, this may represent an identifiable characteristic differentiating one (legitimate) user from another (illegitimate) user. The FIG. 9 series illustrates how a user may draw the user specific pattern totally confined to the fringe region (29), starting the pattern in the upper left corner (20), moving down to the lower left corner (30) and ending up in the lower right corner (31).

A user pattern formed by lines drawn along the edges of the frame is clearly the simplest, easiest to remember and most reproducible alternative, particularly when using sensors with a limited surface area. A weakness associated with drawing pure line patterns is that the number of possible user codes is limited. The number of codes available is limited by the fact that the frame has a small number of corners from which to start the line pattern and that moving the fingertip out of a given corner and into the next provides only two alternatives. Consider the example of a pattern drawn along a four-cornered sensor frame:
Corner 1 (0 lines): 4 possible positions
Corner 2 (1 line): 8 line patterns
Corner 3 (2 lines): 16 line patterns
Corner 4 (3 lines): 32 line patterns
Corner n (n−1 lines): 2ⁿ⁺² line patterns

Note that a line pattern is defined by the start and end points of the line and the direction of motion; and that the same frame corner may be used multiple times in a pattern—the cardinal labels for the corners in the example above refer to their order in the sequence of the pattern rather than their position in the frame.

On the other hand, one may argue that when such user patterns are used for providing added security on top of a fingerprint which by itself is difficult to reproduce, it may be superfluous to use an intricate user code on top of this first-line security measure. A four-line user pattern (64 alternatives) is assumed to be sufficient for most cases, even though the line pattern may be easily extended without the pattern becoming too difficult to execute and memorize.

Splitting the user pattern into two separate line patterns will double the number of code alternatives as a function of line numbers, compared to a single, continuous line pattern. In general, the number of codes (M) as a function of separate line patterns (N) and total number of lines (n) is the following:

M=N×2ⁿ⁺²

The flexibility and versatility of a code can be expanded by introducing <<dots>> in addition to lines when drawing user patterns. Dots may be entered by using the fingertip to make small sideway movements of the finger when located in a certain spot. In line with the underlying principle of making the pattern drawing method reproducible, simple and user friendly (avoiding unnecessary strain on fingers), “dots” may be produced by slight movements of the finger when located in a corner of the frame.

The principle is illustrated in the FIG. 10 series. Here, the fingertip is initially located in the lower left corner (32) of the frame (FIG. 10a). Moving the fingertip a short distance upwards along the left-hand edge of the frame to a new position (33; FIG. 10b) and then back again to the corner (34; FIG. 10c) is equivalent to entering a “dot”. The fingertip may alternatively be moved back-and-forth sideways along the lower edge of the frame, or diagonally back and forth across the sensor surface (2) to yield the same result. However, from an ergonomic and ease of operation point of view, it is better to perform this brief input motion in the pointing direction of the finger (indicated by arrows in FIG. 10b and FIG. 10c). According to a preferred embodiment of the invention, dots are therefore entered as brief, upward back-and-forth motions when the fingertip is located in one of the two lower corners and as brief, downward back-and-forth motions when the fingertip is located in one of the two upper corners. The length of one leg of the back-and-forth motion is usually limited to within 20-40% of the length of the edge of the frame, and maximum 50% of the edge length as indicated by M1 and M2 in FIG. 10b.

The FIG. 11 series shows input of a combination (line plus dot) pattern, in which the graphic symbol associated with “dot movement” or “dot drawing” is a short, double-headed arrow. The pattern is initiated with a fingertip in the upper left corner (20) of the frame (3; FIG. 11a). The fingertip is then moved along the left-hand edge to the lower left corner (35; FIG. 11b) where a single back-and-forth movement (36) is performed. Finally, the fingertip is moved along the lower edge to the lower right corner (37; FIG. 11c) where the user pattern is completed with an input of two dots (38).

The number of dots entered in corners may be limited to a particular threshold. In the example of a limitation to three dots (providing the four alternatives 0, 1, 2 and 3 dots), a formula showing the maximum number of user patterns (M) as a function of line numbers (n) is the following:

M=2²⁺⁴

Consequently, for a simple combination pattern comprising just three lines the number of alternative patterns is 2¹⁰=1024. For combination patterns comprising N separate segments, the number of alternative patterns is:

M=N×2²ⁿ⁺⁴

Thus, by introducing dots as part of user patterns in addition to lines, the number of alternative code patterns may be increased significantly.

It has been stated earlier that a great disadvantage in using fingerprint sensors is the risk of deposition of “readable” fingerprint residues of legitimate users that can be “lifted off” a sensor surface with the intention of fraudulent use. In addition to using just a fringe zone of the sensor surface for input of code patterns, this invention also provides a way of wiping the sensor surface clean of readable fingerprint residues, as illustrated in the FIG. 12 series

In FIG. 12a, the fingertip (39) is initially positioned on top of the left-hand edge of the frame (3) and subsequently moved across the sensor surface (2) to the right-hand edge in a single swipe (40). This kind of movement may be used as a sign to indicate that input of a user pattern is completed. Alternatively, it may be used to indicate start of a user pattern, while two swipes in rapid succession may indicate completion of pattern input. The movement illustrated in FIG. 12b, where the fingertip (41) is moved from the right-hand edge towards the opposing left-hand edge (42) may be used as a correction sign; i.e. that the pattern sequence just drawn was erroneous and should be ignored, and that a new, correct pattern will follow. The vertical movement (44) of the fingertip (43) in FIG. 12c, or a similar upward movement may be used for other signaling purposes related to use of the fingerprint sensor (1).

Some sensor types based on capacitive principles require the establishment of an electrical potential difference (voltage) between the plate array of the sensor and the fingertip. For this reason, such sensors are equipped with an electrically conducting entity that needs to be in contact with the finger during scanning of a fingerprint. The use of a pronounced frame for carrying out the authentication procedure according to present invention may advantageously be combined with use of conducting entities as part of a capacitive sensor (45), as illustrated in the FIG. 13 series. Here, the sensor surface (2) under which a capacitor plate array is located is surrounded by a frame (3), which in FIG. 13b includes a conducting bezel (46), in FIG. 13c a conducting rim (47) and in FIG. 13d a conducting strip (48). The method disclosed herein for drawing user specific patterns will secure that the finger is in continuous contact with the conducting entity and thus allow the sensor to work properly. (The signals related to start, end and correction of pattern input may be somewhat modified, however, e.g. by swiping the sensor surface with a flat finger in contact with the lower edge of the frame).

The FIG. 14 series summarizes various elements of a fingerprint sensor, showing a slightly upright fingertip (16; FIG. 14a) resting in one corner of an elevated frame (3) surrounding a sensor surface (2) and ready for drawing a user pattern. FIG. 14b illustrates that a large part of the fingertip is resting on the frame (3) and the outside device casing, while only a small part (17) is actually in touch with the sensor surface (2). FIG. 14c illustrates further elements used by the disclosed method, comprising a fingertip contact area (20) and a frame (3) comprising edges (18) and corners (19). FIG. 14d illustrates input of a U-shaped line pattern (49) and a line (50) drawn from C across the sensor surface to signal completion of the user pattern.

The FIG. 15 series illustrates principles for mapping the corners of the sensor surface and graphic symbolism used for making reference to a user pattern. In FIG. 15a, capital letters (51) from A to D are used in a clock-wise organization to denote the four corners of the frame. In FIG. 15b, numerals (52) from 1 to 4 are used in a similar manner. FIG. 15c illustrates a rather complex combination pattern, starting in upper left corner with a single dot (53), moving to the upper right corner and entering a double dot (54), moving back to the upper left corner and thereafter returning to the upper right corner and further downward to the lower right corner where a double dot (55) is entered, then onwards to the lower left corner and upwards to the upper left corner entering a single dot (56) and then downward to the lower left corner where a single dot is entered (57) before completing the pattern with a movement to the lower right corner. A simpler symbolism may be used when writing the code patterns by use of plain text or numbers, where dots may be represented by “v”, “o” or “0” and lines by AB, BCD, 12, 32, etc. The user pattern drawn in FIG. 15c may thus be represented as:

AvBvvABCvvDAvDvC, 1o2oo123oo41o4o3, or by the “number” 1020012300410403

While simple user patterns (e.g. BCBA) may be sufficient for most purposes, more complex codes, as the one illustrated in FIG. 15c may be used for particularly important authentication purposes, or used in the same way as PUK codes to unlock the system after a number of failed attempts using the short code.

FIG. 16 illustrates a smart phone (58) comprising a fingerprint sensor (59) on the backside of the phone. The sensor is equipped with a frame (here with elevated edges) and is therefore appropriate for easy scanning of fingerprints and entering a user specific pattern. Both user identification (by means of fingerprint) and authentication (by means of user pattern) can be carried out without the user actually seeing the fingerprint sensor, e.g. when keeping the smart phone in the normal “upside up” position or when the phone is located in a pocket or in a handbag. This augments the security associated with use of this kind of device considerably and makes is well suited for use as an “electronic wallet” and for other purposes that have similar security requirements.

The FIG. 17 series illustrates incorporation of a fingerprint sensor (61; FIG. 17a) as part of a transaction card (60). The sensor arrangement of FIG. 3 may be particularly suited to this particular application. The fingerprint may be scanned with a finger (62) on the sensor surface (61) while the user is pushing the card into a card reader (not shown). With the card resting in the reader, the user may easily enter the user pattern on the sensor surface.

While elevated or sunk sensor frames are particularly well suited for precisely guiding the fingertip during input of user patterns and therefore suitable for operation without visual contact, other embodiments may employ frames that are perceptible by other means, allowing the sensor to be incorporated in plain and smooth surfaces, e.g. within or close to the display region of smart phones.

In such instances, the sensor frame is made perceptible by other means such as being imprinted (permanently), by graphic representation using the display system (temporarily or conditionally), by emitting light (temporarily or conditionally), or through haptic feedback such as by vibrating.

An example of a sensor surrounded by a frame that is not physically distinct from the region where it is incorporated but made perceptible by other means is shown in the FIG. 18 series. FIG. 18a illustrates a sensor (63) comprising a sensor area (64) enclosed by a frame (65). A conceptual construction and positioning of the frame (65) is illustrated in FIG. 18b, where the frame itself may emit light or vibrate. The sensor arrangement is located under a thin glass plate or polymer film (66). Display electronics (LED arrays, etc.) may optionally substitute the conceptual frame arrangement (65) allowing the equipment to visualize the position and size of the frame without the aid of additional signaling systems. FIG. 18c indicates that a fingertip (67) can be positioned flat against the sensor surface and will not sense the frame (65). The terms “in touch with the frame”, “finger overlaying the frame” and similar expressions used throughout this document may thus for some embodiments only signify that the finger is located on top of or close to the virtual representation of the frame.

FIG. 19a illustrates a smart phone (68) with a large display (69) where a fingerprint sensor (63) is incorporated in the display region, e.g. on top of the LED array. The frame of the sensor may be made visible on demand when input of a fingerprint or user specific code is required (e.g. during startup, as part of a transaction or as required by other functions or programs). FIG. 19b illustrates a similar embodiment where a smart phone (75) with a large display (76) incorporates a fingerprint sensor (63) that is located below the display region.

When using small area sensors, a precise input of user patterns may be difficult if the frame is not physically distinct from the surroundings. In such instances, the solution provided in FIG. 20a may prove particularly useful. Here, an enlarged picture (80) of the sensor frame is displayed on the smart phone screen (78). When the user puts a finger (81) on top of the actual fingerprint sensor frame (79), this will be indicated by a graphic representation (82) on the screen. This allows for a more precise maneuvering of the finger during input of user patterns, here illustrated by a simple, two-legged line symbol (83).

As further shown in FIG. 20b, when using devices (77) with touch sensitive screens (78) (smart phones, laptops, computer tablets, etc.), the input of user specific patterns (83) may actually be performed by a finger (81) directly on the screen using the displayed frame (80) as guide.

The frame does not have to be positioned close to the sensor surface, as indicated in the FIG. 21 series. Here, the frame (73) is located at some distance from the sensor surface (71), which may be of advantage when using small (e.g. 6×6 mm) area sensors. This leaves a void positioning area (72) that may constitute part of the equipment casing (70; FIG. 20b), permitting the fingertip (74) to be pushed against the frame edges and use them for guidance while entering lines and dots as part of the user specific code. Such a construction makes the described method applicable also for small area sensors.

The frame itself does not have to constitute part of the equipment incorporating the fingerprint sensor, but may be detached from the latter, as illustrated in the FIG. 22 series. FIG. 22a shows a smart phone (84) equipped with a fingerprint sensor (85) that is about to be slid into a protective holster (86), where the latter comprises a “pocket” (87) at its lower front end. This pocket has cut out a square “window” (88), slightly larger than the sensor (85). The window (88) will become aligned with the fingerprint sensor (85) when the smart phone has been fully entered into the holster, as shown in FIG. 22b. In this configuration, the pocket window (88) serves as a frame and will guide the finger both for fingerprint registration and for recording of user specific code. A similar window arrangement can be put elsewhere on protective holsters (e.g. back side) for alternative sensor locations. When employing such additional utilities that assist in determining the position and size of the fingerprint sensor, the sensor itself may not have to be visible at all.

A detached or separate frame may also be used with a transaction card (93) as shown in the FIG. 23 series. FIG. 23a illustrates a card reader (89) as seen from the front, comprising a card receiving entity (90) with a card slot (91). FIG. 23b illustrates part of the card reader (89) as seen from above, highlighting the card receiving entity (90) carrying a square aperture (92). A transaction card (93) with a fingerprint sensor (94) is about to be entered into the card reader (89). FIG. 23c illustrates that when the card is fully entered, the sensor surface (94) is fully exposed through the aperture, which may then serve as frame and guide when entering fingerprint and user code. This and similar utilities may obviate the need for making the sensor perceptible on the card itself.

The disclosure provides many advantages. The method of the disclosure is very simple and easy to carry out which at the same time represents an ergonomic and strain-free mode of operation.

When a frame is present that can be sensed by a finger, the scanning of fingerprints and entry of a user-specific code can both be achieved without the need for visual contact between the user and the fingerprint sensor. This implies that the sensor may be operated securely and reproducibly even when located on the backside of the equipment into which it is incorporated (mobile phones, smart phones, PCs, computer tablets, etc.) and without the user having eye contact with the operation. One may even carry out the total fingerprint identification and user pattern authentication procedure with the equipment located in the pocket or hand bag of the user—without people in the vicinity being aware of the operation.

Using the sensor surface to enter a user-specific code specific pattern provides the secondary and very important function of wiping clean the sensor surface of any fingerprint residues that may theoretically be used to obtain illegitimate copies or replicas of the authorized user's fingerprint, as the sensor surface would be the obvious place to look for the appropriate fingerprint version.

Another advantage of this embodiment is related to use by elderly people, who often have problems with remembering and entering number codes on numerical keypads due to trembling fingers causing imprecise operation of small number keys. The support and guidance provided by a prominent sensor frame largely eliminates these problems, both due to trembling and imprecision being of less importance and due to simple user patterns being easier to remember than number series.

The invention may be employed as an integrated part of, or for functioning alongside, various devices, including mobile phones, smart phones, computers, computer tablets, credit cards, transaction cards and other equipment utilizing fingerprints for identification and/or access control, where the fingerprint sensors used in connection with such devices employ methods for authentication according to the present invention.

Said fingerprint sensors utilize a system used for interpretation, storage and comparison of data stemming from use of methods according to the present invention, where the system comprises one or more microprocessors, integrated circuits/ASICs, electronic storage media and/or data programs suitable for transforming analog information related to a finger's position, contact area, contact duration and movement upon the sensor surface into a digitized user pattern that may be stored electronically and which, together with digitized fingerprint data can be used to decide equality or inequality relative to stored fingerprint and user pattern combinations and thereby be used to authenticate (confirm) the identity of a person depositing a fingerprint on a sensor surface.

Various improvements and modifications may be made to the above without departing from the scope of the invention. For example, while reference has been made throughout to the “finger” or a user and the corresponding “fingerprint”, it is to be understood that this term will cover all digits, in other words it will explicitly include a user's thumbs and/or toes.

1.-27. (canceled)

28. A method of authenticating a user of an electronic fingerprint sensor (1, 59, 61, 63, 85, 94) comprising:
receiving, at a sensor surface (2, 61, 64, 71, 94) of the electronic fingerprint sensor (1, 59, 61, 63, 85, 94), a finger (12, 62, 81) of said user;
scanning a fingerprint (13) with said electronic fingerprint sensor (1, 59, 61, 63, 85, 94); and
receiving at the same sensor surface (2, 61, 64, 71, 94), a user-specific code;
characterised in that:
receiving a user-specific code comprises the drawing of a user-specific pattern that comprises one or more gestures guided by a perceptible frame (3, 7, 10, 65, 73, 79, 80, 88, 92); wherein
the frame (3, 7, 10, 65, 73, 79, 80, 88, 92) is provided around the perimeter of the sensor surface (2, 61, 64, 71, 94) or a portion thereof;
the gestures comprise a line gesture, which is input by the swiping of a finger (16) along a portion of the sensor surface adjacent to an edge of the frame;
the line gesture comprises a swiping motion from one corner of the frame to another;
the user-specific pattern (49) starts in a corner and ends in a corner of the frame, and wherein
a user is authenticated if the scanned fingerprint matches stored information and if the entered user-specific code matches stored information.

29. The method of claim 28, wherein the gestures comprise a dot gesture.

30. The method of claim 29, wherein the dot gesture comprises a back-and-forth motion (36, 38) having a terminus at a corner of the frame (3, 7, 10, 65, 73, 79, 80).

31. The method of claim 29, wherein dot gestures are entered by the user applying increased finger pressure or a tap one or more times while the fingertip resides in a corner.

32. The method of claim 28, wherein the gestures comprise a swipe gesture (40, 42, 44) across the sensor surface that may indicate start and/or completion of input of a user-specific code, or other instructions related to code input.

33. A user authentication system comprising:
an electronic fingerprint sensor (1, 59, 61, 63, 85, 94) comprising a surface (2, 61, 64, 71, 94) which is suitable for receiving a finger (12, 62, 81) for fingerprint scanning and for receiving a user-specific code comprising a user-specific pattern; characterised in that
the system comprises a perceptible frame (3, 7, 10, 65, 73, 79, 80, 88, 92) for guiding placement of a user's finger (12,62, 81) during a drawing of the user-specific pattern (49) on the sensor surface (2, 61, 64, 71, 94);
the frame is provided around the perimeter of the sensor surface or a portion thereof;
the gestures comprise a line gesture which is input by the swiping of a finger (12, 62, 81) along a portion of the sensor surface (2, 61, 64, 71, 94) adjacent to an edge of the frame;
the line gesture comprises a swiping motion from one corner of the frame (3, 7, 10, 65, 73, 79, 80, 88, 92) to another;
the user-specific pattern (49) starts in a corner and ends in a corner of the frame (3, 7, 10, 65, 73, 79, 80, 88, 92), and wherein
the system further comprises memory means storing fingerprint pattern data and user-specific code data associated with at least one user; and
a processor coupled with said sensor for receiving fingerprint pattern data and for receiving user-specific code data; and coupled with said memory means for comparing said received data with said stored data; and returning an authentication result based on said comparison.

34. The system of claim 33, wherein the frame is perceptible by touch (3, 7, 10).

35. The system of claim 34, wherein the frame is square, rectangular or polygonal, preferably with rounded corners.

36. The system of claim 33, wherein the frame (65) comprises a border bounding or at least partially bounding the perimeter of a sensor surface (64) which is visually demarcated from a surrounding surface of a host device and the sensor surface.

37. The system of claim 33, wherein the frame or a portion thereof comprises a conductive element (46, 47, 48).

38. The system of claim 33, wherein the electronic fingerprint sensor is carried on a host device (84, 93) and the frame is carried on a separate body (86, 90) which receives the host device, in use.

39. A host device comprising the user authentication system of claim 33.

40. The host device of claim 39, being a computer, a mobile computing device, a mobile telephone, a smartphone, a computer tablet, a credit card, a financial transaction card, an identity card and other equipment utilizing fingerprints for identification and/or access control.

41. A computer program product or algorithm encoded with instructions that, when run on a computing device or on sensor-embedded computation facilities enables it to receive fingerprint data and user-specific code data comprising gesture data relating to a user-specific pattern; characterised in that
the user-specific pattern (49) is entered on a sensor surface which is surrounded by a perceptible frame, wherein the pattern comprises a line gesture which is input by the swiping of a finger (16) along a portion of the electronic fingerprint sensor surface adjacent to an edge of the frame (3, 7, 10, 65, 73, 79, 80)
the line gesture comprises a swiping motion from one corner of the frame to another;
the user-specific code pattern (49) starts in a corner and ends in a corner of the frame, and wherein
the program compares the received data to stored data; and returns an authentication result based on said comparison.
